(19) United States
(12) Patent Application Publication
(10) Pub. No.: US 2012/0169633 A1
(43) Pub. Date: Jul. 5, 2012

(54) TOUCH-SENSITIVE DISPLAY DEVICE

(76) Inventors: Wei-Cheng HUANG, Hsinchu City (TW); Li-Chun TAI, Hsinchu City (TW); Yin-Jen LIN, Hsinchu City (TW)

(21) Appl. No.: 13/315,873

(22) Filed: Dec. 9, 2011

(30) Foreign Application Priority Data
Dec. 30, 2010 (CN) 201010621992.1

(51) Int. Cl. G06F 3/041; G09G 3/36

(52) U.S. Cl. 345/173; 345/87

(57) ABSTRACT

A touch-sensitive display device includes a liquid crystal display module and a touch-sensitive element. The touch-sensitive element is attached to a surface of the liquid crystal display module.

### BACKGROUND OF THE INVENTION

a. Field of the Invention

The invention relates to a touch-sensitive display device.

b. Description of the Related Art

Referring to FIG. 1, a touch-sensitive display device 100 includes a capacitive touch-sensitive element 102, and the capacitive touch-sensitive element 102 is attached to the bottom of a cover lens 104 by an optical adhesive (not shown). The cover lens 104 is attached to a front cover 108 by a double-sided adhesive tape 106, and the foregoing components are assembled and then combined with a liquid crystal display module (LCM) 110 and a back frame 112 to form the touch-sensitive display device 100. The liquid crystal display module 110 may include a liquid crystal panel 114 and a backlight module 116. However, the above assembly processes are complicated and time-consuming. Besides, when the capacitive touch-sensitive element 102 is combined with the liquid crystal display module 110, a periphery region outside the active display area of the liquid crystal display module 110 is insulated by a buffer material 118 (such as silicone resin or foam) to prevent foreign matter from entering inside to form light spots. Further, a gap G needs to exist between the capacitive touch-sensitive element 102 and the liquid crystal display module 110 to eliminate the electrostatic adhesion force between the capacitive touch-sensitive element 102 and the liquid crystal display module 110, because the electrostatic adhesion force may result in Newton's rings to deteriorate display quality. However, the gap G certainly increases the overall thickness of the touch-sensitive display device 100. Besides, according to the above design, metal traces of the capacitive touch-sensitive element 102 need to be shielded by a black matrix layer of the cover lens 104 or by a thickened front cover 108, and therefore a thinner touch-sensitive display device 100 is hard to achieve.

Taiwan patent no. M368846 discloses a touch panel adhered to a display screen by an adhesive layer. Taiwan patent application publication no. 201011388 discloses an embedded touch-sensitive liquid crystal panel, where a touch-sensitive element is directly disposed inside the liquid crystal panel. Taiwan patent application publication no. 200949649 discloses a touch-sensitive liquid crystal panel having a liquid crystal layer interposed between a top substrate and a bottom substrate, and an insulating layer, a conductive layer and a buffer layer are formed in succession on an inner surface of the top substrate to form a capacitive touch panel.

### BRIEF SUMMARY OF THE INVENTION

The invention provides a touch-sensitive display device having simplified assembly processes, reduced assembly hours, thin shape and low fabrication costs.

Other objects and advantages of the invention may be further illustrated by the technical features broadly embodied and described as follows. In order to achieve one or a portion of or all of the objects or other objects, one embodiment of the invention provides a touch-sensitive display device including a liquid crystal display module and a touch-sensitive element attached to a surface of the liquid crystal display module.

In one embodiment, an optical adhesive is interposed between the liquid crystal display module and the touch-sensitive element, and the touch-sensitive element is adhered to the surface of the liquid crystal display module by the optical adhesive.

In one embodiment, a double-sided adhesive tape is disposed in a non-active area of the liquid crystal display module, and the touch-sensitive element is adhered to the surface of the liquid crystal display module by the double-sided adhesive tape.

In one embodiment, the liquid crystal display module includes a top polarizer and a bottom polarizer opposite the top polarizer, and the touch-sensitive element is adhered to the top polarizer.

In one embodiment, the touch-sensitive element includes a transparent substrate and a touch-sensitive circuit printed on a surface of the transparent substrate.

In one embodiment, the touch-sensitive element and the liquid crystal display module are confined in a front bezel and attached to a back frame.

In one embodiment, the touch-sensitive display device includes a tape for limiting the position of the touch-sensitive element and the liquid crystal display module and adhering the touch-sensitive element and the liquid crystal display module to a back frame.

Another embodiment of the invention provides a touch-sensitive display device having a liquid crystal panel and a backlight module. The backlight module is disposed on one side of the liquid crystal panel and including a light source, a light guide plate capable of guiding a light beam emitted by the light source, and a film set disposed between the light guide plate and the liquid crystal panel. The film set includes at least a touch-sensitive element, a diffusion sheet and a brightness enhancement film stacked with each other.

Another embodiment of the invention provides a touch-sensitive display device having a liquid crystal panel, a backlight module and a touch-sensitive circuitry layer. The backlight module includes a light source, a light guide plate capable of guiding a light beam emitted by the light source, and an optical film set disposed between the light guide plate and the liquid crystal panel. The optical film set includes at least a diffusion sheet and a brightness enhancement film stacked with each other. The touch-sensitive circuitry layer is printed on at least one of the liquid crystal panel, the light guide plate and the optical film set.

The embodiment or the embodiments of the invention may have at least one of the following advantages. According to the above embodiments, the touch-sensitive element is adhered to a surface of the liquid crystal display module, so the touch-sensitive element and the liquid crystal display module are combined with each other as a single piece. Further, the touch-sensitive element and the liquid crystal display module that are combined with each other as a single piece are directly attached to a back frame by a fastener. Therefore, assembly processes of the touch-sensitive display device are simplified, and assembly hours, packing and transportation costs, the possibility of damage to materials, and the overall thickness of a finished product are all reduced. Besides, since the touch-sensitive element and the liquid crystal display module are integrated as one piece, the buffer material used in a conventional design is no longer needed to further reduce fabrication costs, and possible electrostatic adhesion between the touch-sensitive element and the liquid crystal display module is also avoided. Similarly, the touch-sensitive element is not liable to bend due to gravity to avoid the formation of Newton's rings and thus improve display quality. In addition, the touch-sensitive element may be stacked with optical films to together form a film set to therefore lower production defective rate and material costs for adhesion. Besides, a touch-sensitive circuitry layer may be directly printed on at least one of a liquid crystal panel, a light guide plate and an optical film set to further reduce fabrication costs and the overall thickness of a finished product.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a partial cross-section of a conventional touch-sensitive display device.

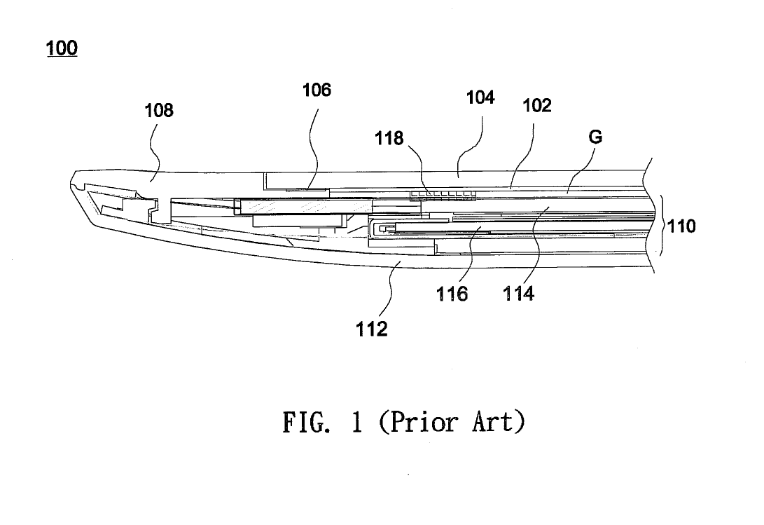

FIG. 2 shows a partial cross-section of a touch-sensitive display device according to an embodiment of the invention.

FIG. 3 shows a partial cross-section of a touch-sensitive display device according to another embodiment of the invention.

FIG. 4 shows a partial cross-section of a touch-sensitive display device according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

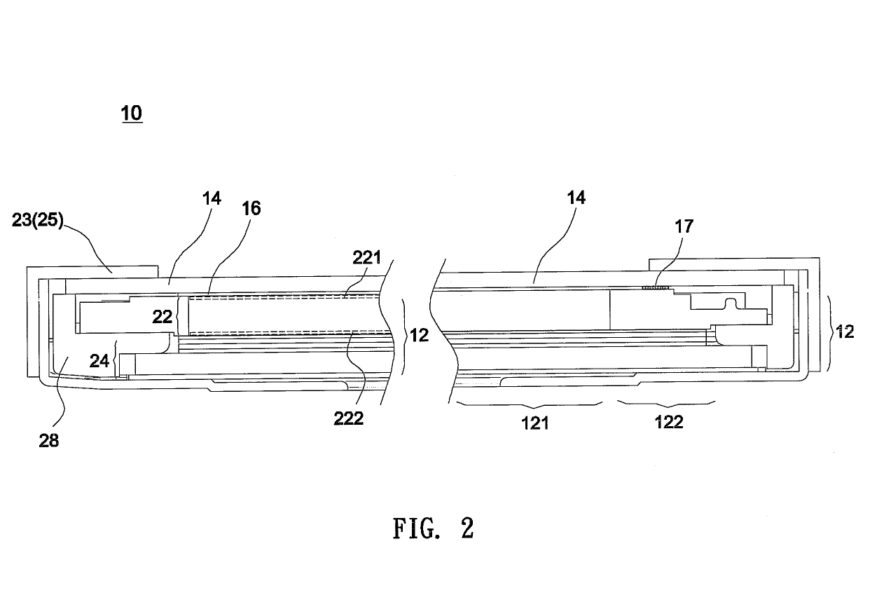

Referring to FIG. 2, a touch-sensitive display device 10 includes a liquid crystal display module 12 and a touch-sensitive element 14. The liquid crystal display module 12 may include a liquid crystal panel 22 and a backlight module 24 disposed on one side of the liquid crystal panel 22. The liquid crystal display module 12 has an active display area 121 and a non-active area 122. The touch-sensitive element 14 is disposed on the liquid crystal display module 12 and touches a top surface of the liquid crystal display module 12. For example, an optical adhesive 16 may be interposed between the touch-sensitive element 14 and the liquid crystal display module 12, and the touch-sensitive element 14 is adhered to the liquid crystal display module 12 by the optical adhesive 16. Alternatively, a double-sided adhesive tape 17 may be disposed in the non-active area 122 of the liquid crystal display module 12, and the touch-sensitive element 14 is adhered to the liquid crystal display module 12 by the double-sided adhesive tape 17. The touch-sensitive element 14 may include a transparent substrate and a touch-sensitive circuit printed on a surface of the transparent substrate, and the transparent substrate may be a glass substrate or a plastic substrate. In one embodiment, a top polarizer 221 and a bottom polarizer 222 are respectively disposed on a top side and a bottom side of the liquid crystal panel 22, and the touch-sensitive element 14 may be adhered to the top polarizer 221 of the liquid crystal panel 22. Further, after the touch-sensitive element 14 is attached to the liquid crystal panel 22, the touch-sensitive element 14 and the liquid crystal display module 12 are combined with each other by a tape 23 or are confined in a front bezel 25. Then, the touch-sensitive element 14 and the liquid crystal display module 12 that are combined with each other as a single piece are attached to a back frame 28.

According to the above embodiment, the touch-sensitive element 14 is adhered to a surface of the liquid crystal display module 12, so the touch-sensitive element 14 and the liquid crystal display module 12 are combined with each other as a single piece. Further, the touch-sensitive element 14 and the liquid crystal display module 12 that are combined with each other as a single piece are directly attached to a back frame 28 by a fastener such as a tape 23 or a front bezel 25. Therefore, assembly processes of the touch-sensitive display device are simplified, and assembly hours, packing and transportation costs, the possibility of damage to materials, and the overall thickness of a finished product are all reduced. Besides, since the touch-sensitive element 14 and the liquid crystal display module 12 are integrated as one piece, the buffer material used in a conventional design is no longer needed to further reduce fabrication costs, and possible electrostatic adhesion between the touch-sensitive element 14 and the liquid crystal display module 12 is also avoided. Similarly, the touch-sensitive element 14 is not liable to bend due to gravity to avoid the formation of Newton's rings and thus improve display quality.

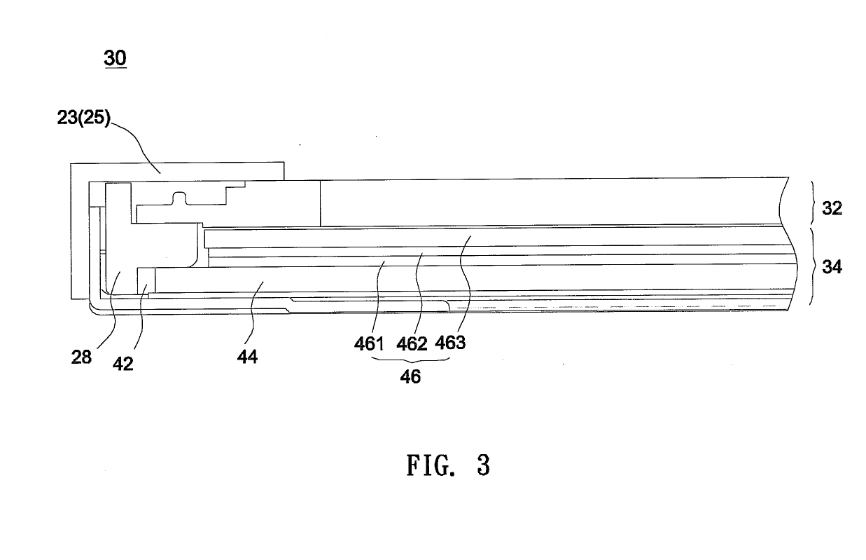

Referring to FIG. 3, a touch-sensitive display device 30 includes a liquid crystal panel 32 and a backlight module 34 disposed on one side of the liquid crystal panel 32. The backlight module 34 includes at least one light source 42, a light guide plate 44, and a film set 46 interposed between the light guide plate 44 and the liquid crystal panel 32. The liquid crystal panel 32 is adhered to the back frame 28 by a tape 23 or confined in the back frame 28 by a front bezel 25. The light guide plate 44 is capable of guiding a light beam emitted by the light source 42, and the film set 46 may include optical films such as a brightness enhancement film 461 and a diffusion sheet 462 and a touch-sensitive element 463. In this embodiment, since the touch-sensitive element 463 is stacked with optical films to together form a film set 46, assembly processes for the touch-sensitive display device 30 are similarly simplified, and assembly hours and the overall thickness of a finished product are also reduced. Besides, the touch-sensitive element 463 is no longer adhered to the liquid crystal panel 32 to therefore lower production defective rate and material costs for adhesion. Note the touch-sensitive element 463 may be, but not limited to, disposed on the diffusion sheet 462 as shown in FIG. 3.

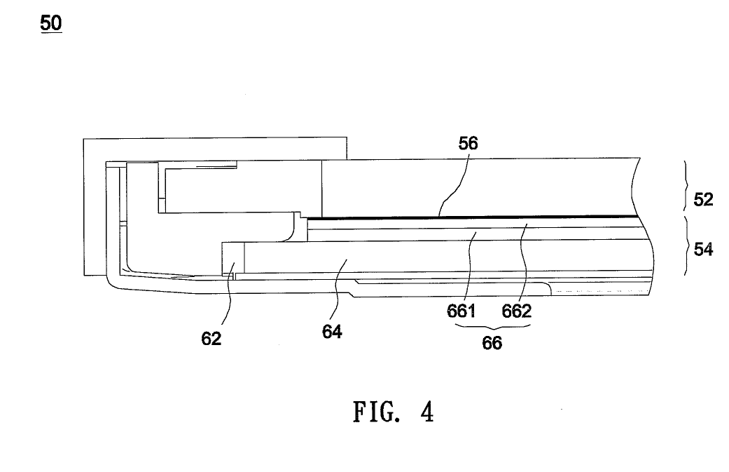

Referring to FIG. 4, a touch-sensitive display device 50 includes a liquid crystal panel 52 and a backlight module 54 disposed on one side of the liquid crystal panel 52. The backlight module 54 includes at least one light source 62, a light guide plate 64, and an optical film set 66 interposed between the light guide plate 64 and liquid crystal panel 52. The light guide plate 64 is capable of guiding a light beam emitted by the light source 62, and the optical film set 66 may include a brightness enhancement film 661, a diffusion sheet 662 and other optical film. A touch-sensitive circuitry layer 56 is directly printed on the diffusion sheet 662 of the optical film set 66. In this embodiment, since the touch-sensitive circuitry layer 56 is directly printed on an optical film, a transparent substrate may be omitted to further reduce fabrication costs and the overall thickness of a finished product. Certainly, the touch-sensitive circuitry layer 56 is not limited to be printed on the diffusion sheet 662. In alternate embodiments, the touch-sensitive circuitry layer 56 may be printed on a surface of the light guide plate 64, a surface of the liquid crystal panel 52, inner components of the liquid crystal panel 52, or other optical film of the optical film set 66.

The embodiment or the embodiments of the invention may have at least one of the following advantages. According to the above embodiments, the touch-sensitive element is adhered to a surface of the liquid crystal display module, so the touch-sensitive element and the liquid crystal display module are combined with each other as a single piece. Further, the touch-sensitive element and the liquid crystal display module that are combined with each other as a single piece are directly attached to a back frame by a fastener. Therefore, assembly processes of the touch-sensitive display device are simplified, and assembly hours, packing and transportation costs, the possibility of damage to materials, and the overall thickness of a finished product are all reduced. Besides, since the touch-sensitive element and the liquid crystal display module are integrated as one piece, the buffer material used in a conventional design is no longer needed to further reduce fabrication costs, and possible electrostatic adhesion between the touch-sensitive element and the liquid crystal display module is also avoided. Similarly, the touch-sensitive element is not liable to bend due to gravity to avoid the formation of Newton's rings and thus improve display quality. In addition, the touch-sensitive element may be stacked with optical films to together form a film set to therefore lower production defective rate and material costs for adhesion. Besides, a touch-sensitive circuitry layer may be directly printed on at least one of a liquid crystal panel, a light guide plate and an optical film set to further reduce fabrication costs and the overall thickness of a finished product.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A touch-sensitive display device, comprising:
a liquid crystal display module; and
a touch-sensitive element attached to a surface of the liquid crystal display module.

2. The touch-sensitive display device as claimed in claim 1, further comprising:
an optical adhesive interposed between the liquid crystal display module and the touch-sensitive element, wherein the touch-sensitive element is adhered to the surface of the liquid crystal display module by the optical adhesive.

3. The touch-sensitive display device as claimed in claim 1, further comprising:
a double-sided adhesive tape disposed in a non-active area of the liquid crystal display module, wherein the touch-sensitive element is adhered to the surface of the liquid crystal display module by the double-sided adhesive tape.

4. The touch-sensitive display device as claimed in claim 1, wherein the liquid crystal display module comprises a top polarizer and a bottom polarizer opposite the top polarizer, and the touch-sensitive element is adhered to the top polarizer.

5. The touch-sensitive display device as claimed in claim 1, wherein the touch-sensitive element comprises:
a transparent substrate; and
a touch-sensitive circuit printed on a surface of the transparent substrate.

6. The touch-sensitive display device as claimed in claim 1, further comprising:
a front bezel, wherein the touch-sensitive element and the liquid crystal display module are confined in the front bezel and attached to a back frame.

7. The touch-sensitive display device as claimed in claim 1, further comprising:
a tape for limiting the position of the touch-sensitive element and the liquid crystal display module and adhering the touch-sensitive element and the liquid crystal display module to a back frame.

8. A touch-sensitive display device, comprising:
a liquid crystal panel; and
a backlight module disposed on one side of the liquid crystal panel and comprising:
a light source;
a light guide plate capable of guiding a light beam emitted by the light source; and
a film set disposed between the light guide plate and the liquid crystal panel, wherein the film set comprises at least a touch-sensitive element, a diffusion sheet and a brightness enhancement film stacked with each other.

9. The touch-sensitive display device as claimed in claim 8, wherein the touch-sensitive element is disposed on the diffusion sheet.

10. The touch-sensitive display device as claimed in claim 8, wherein the touch-sensitive element comprises:
a transparent substrate; and
a touch-sensitive circuit printed on a surface of the transparent substrate.

11. The touch-sensitive display device as claimed in claim 8, further comprising:
a front bezel, wherein the liquid crystal panel is confined in the front bezel and attached to a back frame.

12. The touch-sensitive display device as claimed in claim 8, further comprising:
a tape for limiting the position of the liquid crystal panel and adhering the liquid crystal panel to a back frame.

13. A touch-sensitive display device, comprising:
a liquid crystal panel;
a backlight module, comprising:
a light source;
a light guide plate capable of guiding a light beam emitted by the light source; and
an optical film set disposed between the light guide plate and the liquid crystal panel, wherein the optical film set comprises at least a diffusion sheet and a brightness enhancement film stacked with each other; and
a touch-sensitive circuitry layer printed on at least one of the liquid crystal panel, the light guide plate and the optical film set.

14. The touch-sensitive display device as claimed in claim 13, wherein the touch-sensitive circuitry layer is printed on the diffusion sheet.
